(19) United States
(12) Patent Application Publication
(10) Pub. No.: US 2026/0080869 A1
(43) Pub. Date: Mar. 19, 2026

(54) VOICE-BASED MONETIZATION SYSTEM FOR ARTIFICIAL INTELLIGENCE AND VIRTUAL PLATFORMS

(71) Applicant: Stephen M. Byrd, Upper Marlboro, MD (US)

(72) Inventor: Stephen M. Byrd, Upper Marlboro, MD (US)

(21) Appl. No.: 19/277,494

(22) Filed: Jul. 23, 2025

Related U.S. Application Data
(63) Continuation-in-part of application No. 17/408,858, filed on Aug. 23, 2021, now abandoned.

(51) Int. Cl. G10L 15/22; G06Q 30/0241; G06Q 30/0251

(52) U.S. Cl. CPC G10L 15/22; G06Q 30/0251; G06Q 30/0276

(57) ABSTRACT

A system and method for delivering monetized voice interactions via artificial intelligence (AI) platforms, voice assistants, smart devices, and immersive environments, including virtual and augmented reality. The system facilitates real-time retrieval and presentation of contextually relevant advertisements and content in response to user-initiated voice prompts or search queries. Through a voice-based user interface, users can access virtual products and services, execute voice-activated transactions, and receive information in a seamless and non-disruptive manner. The system is configured for integration with third-party AI and voice platforms, including but not limited to OpenAI, Siri, and Alexa, and may operate independently as a dedicated voice marketing assistant. The system architecture supports both embedded and standalone deployments across multiple device ecosystems.

### CROSS REFERENCE TO RELATED APPLICATIONS

The present application is a Continuation-In-Part application of U.S. patent application Ser. No. 17/408,858 filed on 23 Aug. 2021, which are herein incorporated in their entirety.

### FIELD OF THE DISCLOSURE

The present disclosure relates to systems and methods for delivering monetized, context-aware voice advertisements via AI platforms, immersive environments, voice assistants, and standalone voice marketing systems.

### BACKGROUND OF THE RELATED ART

Voice assistants like Siri, Alexa, and Google Assistant provide hands-free user interaction, but they lack integrated systems for voice-based advertising and monetization. While digital ads are widespread, they are typically visual, static, and disruptive especially in immersive environments such as virtual reality (VR).

Additionally, AI platforms like OpenAI's ChatGPT provide rich information via text or voice but do not include mechanisms for serving contextually relevant voice ads or facilitating voice-activated commerce. Current advertising models in VR and AI environments fail to deliver seamless, interactive monetization that feels native to the experience.

There is a clear gap in the art for a system that enables contextual, voice-driven monetization across multiple platforms including AI, VR, smart TVs, and voice assistants while also functioning as a standalone voice marketing assistant. This system must preserve user immersion and enable frictionless commerce, providing value to both users and advertisers.

### DESCRIPTION OF RELATED ARTS

US granted patent, U.S. Ser. No. 7,136,470B1 discloses a conventional telecommunications systems play a standard ringing tone to the caller while waiting for the recipient to answer. However, this waiting period is often unproductive. A prior approach proposed replacing the ringing tone with relevant information such as advertisements, delivered to the caller before the call is answered. These ads could be location-based or interest-specific and funded by advertisers, offering potential cost savings to the caller. This system enables passive ad delivery during idle call time, but it is limited to telephony contexts and does not support active user engagement, AI-driven personalization, or multimodal platforms like smart devices, virtual environments, or conversational interfaces.

‘Nova Spivack et al.’ in a US granted patent U.S. Pat. No. 11,494,991B2, discloses existing systems have explored the use of digital assistants within augmented reality (AR) environments, enabling users to interact with virtual elements overlaid on the physical world. These systems often use directional lenses or display apparatuses as portals between real and digital spaces. The digital assistant can be presented within the AR environment and respond to user commands by triggering actions or manipulating virtual content. Some systems incorporate adaptive learning, allowing the assistant to learn from user behavior and interactions within the AR space. While these systems offer immersive interaction, they primarily focus on AR-specific content manipulation and lack dedicated voice-based monetization mechanisms, contextual commerce integration, or scalable deployment across smart platforms and AI ecosystems.

In yet another patent application, bearing application number U.S. 20210134263A1, Victor et al. discloses a platform and system for the transcription of electronic online content from mostly visual/text format to an aural format, adapted for being read by an intelligent speaker system. It specifically discloses an automated engine with artificial intelligence and/or machine learning for the transformation of written websites into audioenabled content for use in association with new technology intelligent speakers, for implementing data mining, processing, and summarizing tools.

Another granted patent to Apple Inc., U.S. Pat. No. 9,548,050B2 filed by Thomas et al. teaches about an intelligent automated assistant system that engages with the user in an integrated, conversational manner using natural language dialog, and invokes external services when appropriate to obtain information or perform various actions.

None of the aforementioned prior art teaches or suggests a monetized, voice-based AI digital assistant system that delivers contextually relevant voice advertisements and interactive commerce experiences across platforms such as OpenAI, smart devices, and virtual reality environments. In particular, the prior art does not disclose a standalone or integrable voice assistant that enables businesses to target users with live, keyword-triggered voice ads based on user prompts, location, or immersive interactions, nor systems optimized for seamless integration into smart glasses, smart TVs, and conversational AI platforms.

### SUMMARY OF THE INVENTION

Embodiments of the present disclosure relate to a voice-based digital assistant platform that facilitates the delivery of monetized, contextually relevant advertisements across various interfaces including artificial intelligence-based systems such as OpenAI, virtual reality environments, smart assistants like Siri, Alexa, smart televisions, and as a standalone application.

The disclosed system comprises a voice-enabled advertising module that interfaces with a data storage populated with promotional content from participating businesses. The system may also be equipped with a keyword recognition engine and speech processing module that enable it to respond to text or voice prompts initiated by users across supported platforms.

In some embodiments, the system may be integrated directly into conversational AI platforms such as OpenAI. When a user asks a question, the system analyzes the prompt, identifies keywords or subject matter (e.g., “trademarks” or “personal injury lawyers”), and delivers a voice advertisement relevant to that topic. For instance, upon detecting a legal-related prompt, the system may interject or follow up with a voiced ad promoting nearby legal services or firms.

The platform supports programmatic ad selection based on dynamic keyword matching, business category relevance, geographic user data (if available), and historical engagement behavior. Ads may be ranked and selected based on performance criteria and user interest patterns.

Embodiments also include a standalone deployment mode in which the voice assistant functions independently from any third-party system. This version provides direct interaction with users, allowing them to request product information, hear ads, or complete purchases through a fully voice-controlled interface.

For smart home devices and televisions, the assistant overlays or supplements existing software systems to deliver voiced advertisements during appropriate user interactions or idle moments. These ads may include spoken promotions about local deals, online offers, or personalized shopping recommendations.

In virtual reality environments, Voicee introduces a non-intrusive voice-based monetization framework designed to preserve immersion while enabling commerce. The system supports in-world interactions such as asking for product details (“Tell me more about this painting”) or initiating purchases (“Buy this outfit”) via voice command.

Voicee can further enable interactive “experiential” ads in VR, where users can talk to branded virtual representatives or hear tailored voice prompts as they explore digital environments. These ads adapt in real time to user behavior, preferences, and contextual cues such as virtual location or in-app navigation.

A key aspect of the invention is its ability to deliver voice-based, context-aware, and user-initiated monetization that respects the flow of user interaction across different platforms. In this regard, the system does not rely on traditional pop-ups or banners, which can interrupt or degrade user experience.

The system may also support an optional subscription model, allowing users to disable all voice ads in exchange for a fee, thereby offering flexible monetization for both users and content providers.

The keyword recognition module and speech processing engine together form a hybrid analysis layer that can distinguish between generic conversation and purchase-related queries, thus ensuring ads are only triggered when contextually appropriate.

When embedded into platforms such as OpenAI, the system interfaces with natural language output to determine whether a prompt meets relevance thresholds for ad delivery. If a match is found, the system initiates an ad pull from its storage and streams or inserts it into the voice or text response.

Embodiments include a search module configured to match prompts to businesses based on keyword taxonomy, geolocation, service category, and ad targeting rules. Matching ads are then prioritized by relevance score and historical conversion rates.

The system architecture supports both synchronous and asynchronous ad delivery, meaning it can insert voice ads immediately in response to a live query or trigger voice playback at a later moment depending on user interaction flows.

A reporting and analytics module captures real-time data on ad impressions, engagements, clicks (if applicable), voice confirmations, and completed transactions. These metrics help refine the ad delivery model using machine learning and A/B testing techniques.

The voice assistant supports multilingual voice processing, allowing the platform to operate globally and personalize user experiences based on regional language preferences and accents.

In some embodiments, the assistant may store historical user interactions, allowing it to tailor future voice ads based on user behavior, interests, and shopping patterns. It may also avoid repeating ads or reintroducing irrelevant content to returning users.

Voicee includes privacy-preserving protocols to anonymize user input data and protect personally identifiable information, especially in contexts where the assistant operates on open platforms like OpenAI or in shared VR environments.

The platform is modular and can be customized by third-party developers to create voice-interactive brand ambassadors, customized voice campaigns, or location-aware promotions in physical or virtual spaces.

In e-commerce settings, Voicee facilitates direct transactions by allowing users to confirm purchases, schedule appointments, or access promotional offers using only voice commands. Payment credentials and delivery preferences may be stored securely within user profiles for rapid checkouts.

In VR implementations, the system recognizes virtual geolocations and in-world cues (e.g., proximity to branded content) to deliver ambient, voice-activated prompts such as “Would you like to know more about this store?” or “You're near the VR Café, want to check the menu?”

Voicee may also facilitate the sale of virtual goods, experiences, and services by allowing users to initiate purchases of in-game items, digital clothing, media, and more, all through contextual voice queries and commands.

In summary, Voicee represents a cross-platform, voice-first marketing system that delivers targeted, monetized audio content in response to user queries and behaviors across a wide range of digital environments. The system is adaptable, user-aware, and commercially oriented, positioning voice as the next frontier of AI-driven monetization.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating a system, according to some embodiments of the present disclosure.

FIG. 2 is a block diagram further illustrating the system from FIG. 1, according to some embodiments of the present disclosure.

FIG. 3 is a block diagram further illustrating the system from FIG. 1, according to some embodiments of the present disclosure.

FIG. 4 is a block diagram further illustrating the system from FIG. 1, according to some embodiments of the present disclosure.

FIG. 5A is a flowchart illustrating a method, according to some embodiments of the present disclosure.

FIG. 5B is a flowchart extending from FIG. 5A and further illustrating the method, according to some embodiments of the present disclosure.

FIG. 5C is a flowchart extending from FIG. 5B and further illustrating the method from FIG. 5A, according to some embodiments of the present disclosure.

FIG. 5D is a flowchart extending from FIG. 5C and further illustrating the method from FIG. 5A, according to some embodiments of the present disclosure.

FIG. 6 is a flowchart further illustrating the method from FIG. 5A, according to some embodiments of the present disclosure.

FIG. 8 is a block diagram illustrating the integration of a voice-based monetization system into a virtual reality (VR) environment, showing user interaction with virtual products and contextual voice ad delivery, according to some embodiments of the present disclosure.

FIG. 9 is a block diagram further illustrating system interaction with OpenAI and other AI-driven platforms, demonstrating the parsing of user prompts, keyword matching, and voice advertisement delivery flow, according to some embodiments of the present disclosure.

FIG. 10 is a block diagram illustrating the use of the system as a standalone voice assistant deployed on smart devices, including mobile phones and smart TVs, configured to deliver location-aware, real-time voice ads, according to some embodiments of the present disclosure.

### DETAILED DESCRIPTION OF THE INVENTION

Unless otherwise defined, all technical terms used herein related to voice recognition, artificial intelligence, machine learning, search algorithms, and e-commerce systems have the same meaning as commonly understood by one of ordinary skill in the relevant arts of speech processing, digital assistants, and electronic commerce. It will be further understood that terms such as “speech recognition,” “natural language processing,” “machine learning,” “artificial intelligence,” and other technical terms commonly used in the fields of voice commerce and digital assistants should be interpreted as having meanings consistent with their usage in the context of this specification and the current state of voice shopping technology. These terms should not be interpreted in an idealized or overly formal sense unless expressly defined herein. For brevity and clarity, well-known functions or constructions related to voice processing, search algorithms, or e-commerce systems may not be described in detail.

The terminology used herein describes particular embodiments of the voice-based shopping system and is not intended to be limiting. As used herein, singular forms such as “a speech recognition module,” “an adaptive feedback module,” and “the hierarchical search process” are intended to include plural forms as well, unless the context clearly indicates otherwise. Similarly, references to “voice input” or “search process” should be understood to include multiple instances or iterations of such elements, where applicable.

With reference to the use of the words “comprise” or “comprises” or “comprising” in describing the components, processes, or functionalities of the voice-based shopping system, and in the following claims, unless the context requires otherwise, these words are used on the basis and clear understanding that they are to be interpreted inclusively rather than exclusively. For example, when referring to “comprising a speech recognition module,” the term should be understood to mean including but not limited to the described speech recognition capabilities, and may include additional related functionalities or components not explicitly described. Each instance of these words is to be interpreted inclusively in construing the description and claims, particularly in relation to the modular and adaptable nature of the voice shopping system described herein.

Furthermore, terms such as “connected,” “coupled,” or “communication with” as used in describing the interaction between various modules of the system (such as between the speech processing module and the adaptive feedback module) should be interpreted to include both direct connections and indirect connections through one or more intermediary components, unless explicitly stated otherwise. References to “processing,” “analyzing,” or “adapting” should be understood to encompass both real-time operations and delayed or batch processing, unless specifically limited to one or the other in the context.

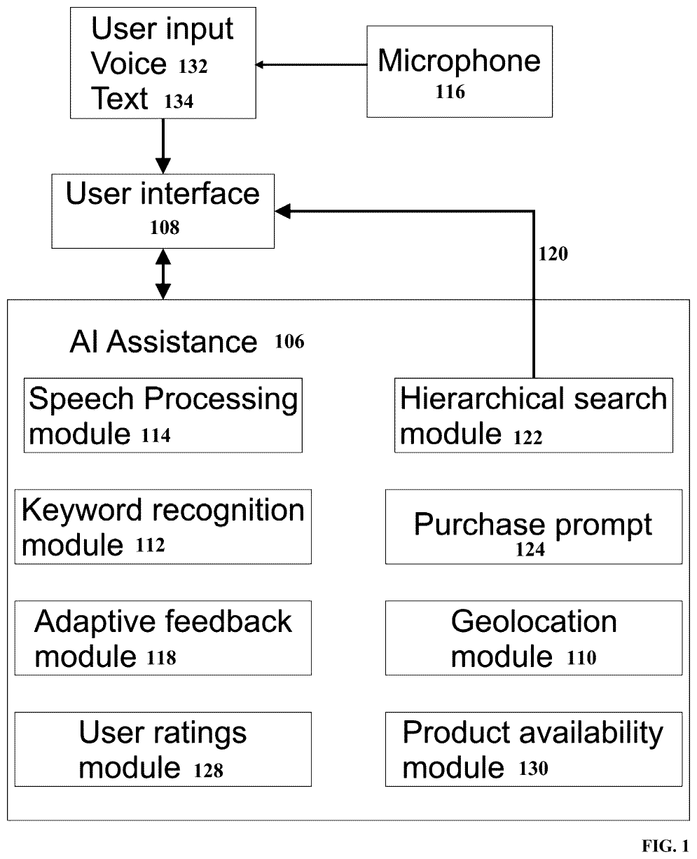

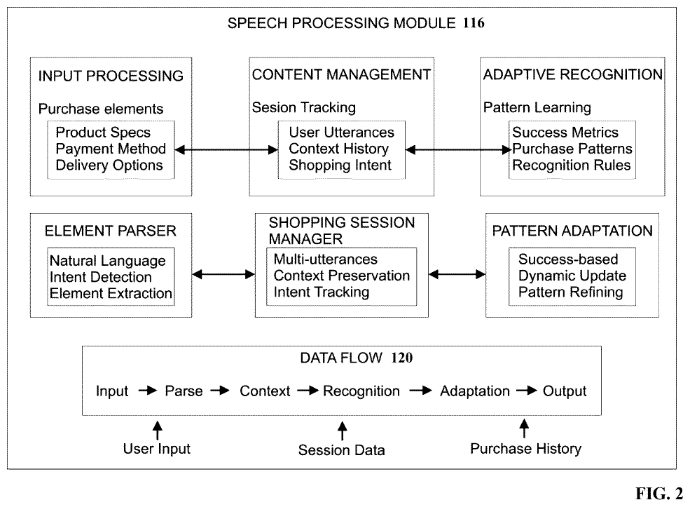

In some aspects thereof, FIG. 1 is a block diagram that describes a system 102, according to some embodiments of the present disclosure. In some embodiments, the system 102 may include a data storage 104 populated with a plurality of merchant offers'data records, an artificial intelligence-based digital assistant module 106 connected to the data storage 104 over a network interface configured for two-way communication between the artificial intelligence-based digital assistant module 106 and a plurality of computing devices, an interactive graphical user interface 108 configured to receive text input from a user, a geolocation module 110 configured to generate geolocation data of the user, a keyword recognition module 112 configured to process text-based commands from the user and transcode the text-based commands into voice data, a speech processing module 114 configured to: process audio input 116 from the user, an adaptive feedback module 118 configured to: interject 120 during user inputs based on learned purchase flows, a hierarchical search module 122 configured to: a purchase prompt 124, confirmation module 126 configured to enable users to complete purchases using stored payment methods and provide delivery or pickup options, a user ratings module 128 configured to allow users to hear ratings for products they may be interested in, a product availability notifications module 130 may configured to notify users when products may be available and facilitate automatic purchases, by voice 132, and/or text 134.

In some embodiments, at least a first microphone configured to receive an audio input from the user. The speech processing module 114 may be further configured to parse the audio input to derive at least one keyword from the audio input. Distinguish purchase-related inputs from standard speech through trained recognition patterns. Generate contextual purchase prompts based on the distinguished purchase-related inputs.

In some embodiments, provide real-time guidance to users for proper voice input format based on historical successful purchase patterns. Dynamically adjust guidance based on user response patterns. Implement a two-step search process that first prioritizes brand-specific queries before performing broader keyword searches. When a brand name may be recognized, initially limit search results to that brand's offerings before expanding to related products.

In some embodiments, when no brand name may be detected, proceed with keyword-based search using identified relevant terms. Filter out non-value-adding words from search queries to improve search precision. The digital assistant module 106 may be configured to receive input data. The digital assistant module 106 may be configured to parse the input data for at least one keyword. The digital assistant module 106 may be coupled to the data storage 104 and configured to fetch at least one merchant may offer′ data record based on the at least one keyword. The digital assistant module 106 may be configured to transcode the at least one merchant may offer′ data record into voice data. The digital assistant module 106 may be configured to transmit the voice data over the network interface to the plurality of computing devices.

In some embodiments, the adaptive feedback module 118 may be further configured to: Track common error patterns in user voice may input. Generate personalized correction suggestions based on user's historical interaction patterns. Store successful voice input patterns for future reference and guidance. Provide progressive guidance by starting with minimal intervention and increasing assistance based on user response.

In some embodiments, the filter algorithm of the hierarchical search module 122 may be configured to: Maintain a dynamic database of non-value-adding words. Analyze word frequency and correlation with successful searches. Remove common filler words while preserving context-specific terms. Adapt filtering rules based on search success rates. In some embodiments, the speech processing module 114 may implement a learning algorithm that: Tracks successful purchase-related voice interactions. Identifies patterns in voice may input that lead to completed purchases. Maintains separate recognition models for purchase-related and non-purchase speech. In some embodiments, the adaptive feedback module implements a purchase flow training model that: Analyzes historical purchase completion data. Identifies common points of user hesitation or confusion. Generates context-appropriate intervention may trigger. Customizes guidance based on product category and user expertise level.

On the other hand, the FIG. 2 is a block diagram that further describes the system 102 from FIG. 1, according to some embodiments of the present disclosure. In some embodiments, the speech processing module 114 may be further configured to: Identify and parse specific elements from purchase-related inputs. Maintain context awareness across multiple user utterances within a single shopping session. Adapt speech recognition patterns based on successful purchase completions.

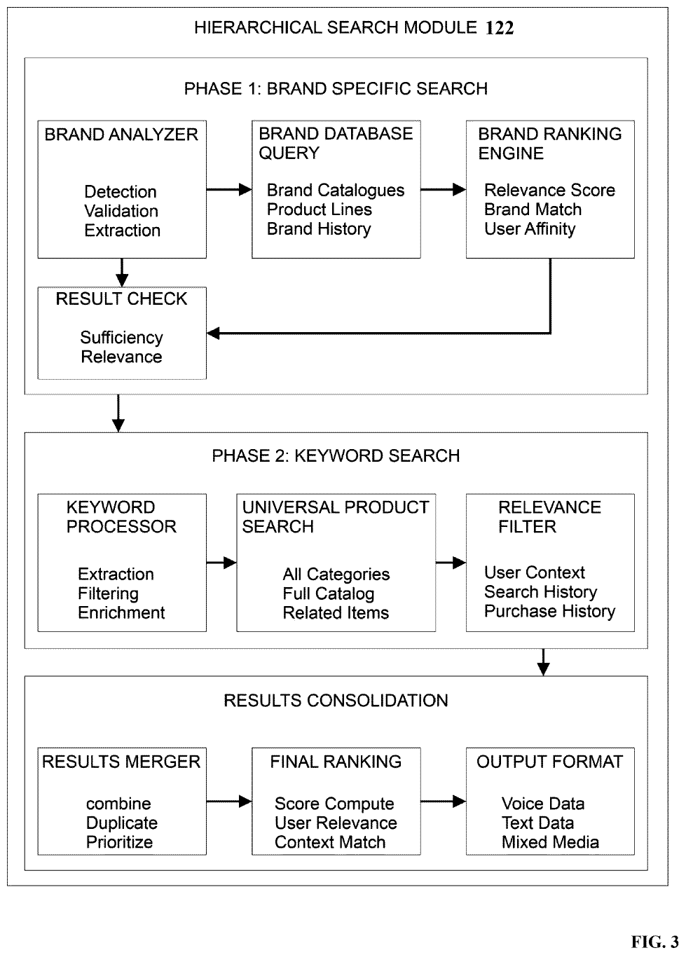

Further, the FIG. 3 is a block diagram that further describes the system 102 from FIG. 1, according to some embodiments of the present disclosure. In some embodiments, the hierarchical search module's two-step search process. Queries brand-specific product databases. Ranks results based on brand relevance scores. Activates when no brand may be identified or brand-specific results may be insufficient. Performs keyword-based search across all product categories. Applies relevance filtering based on user context and history.

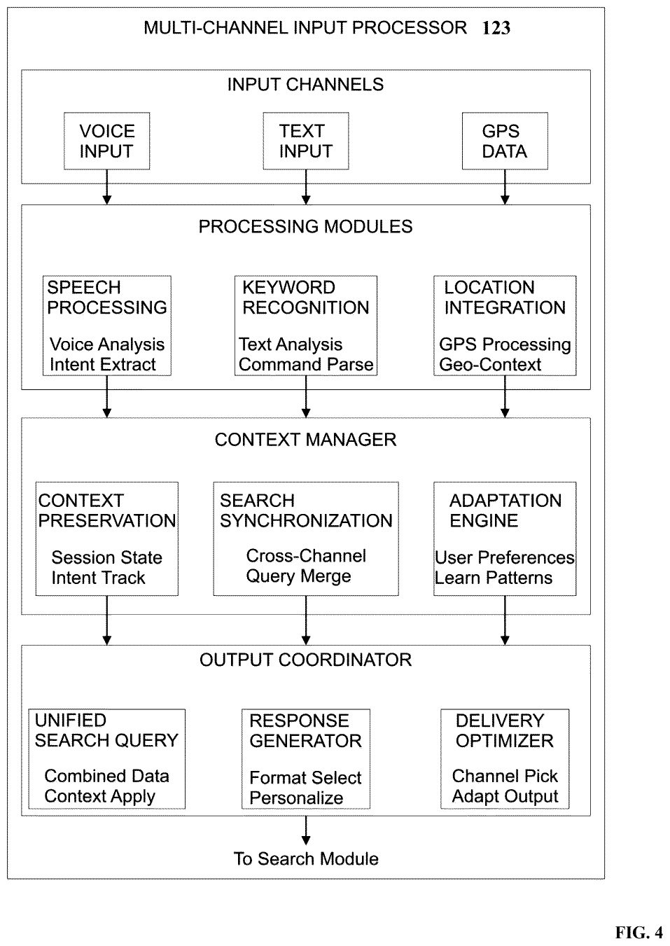

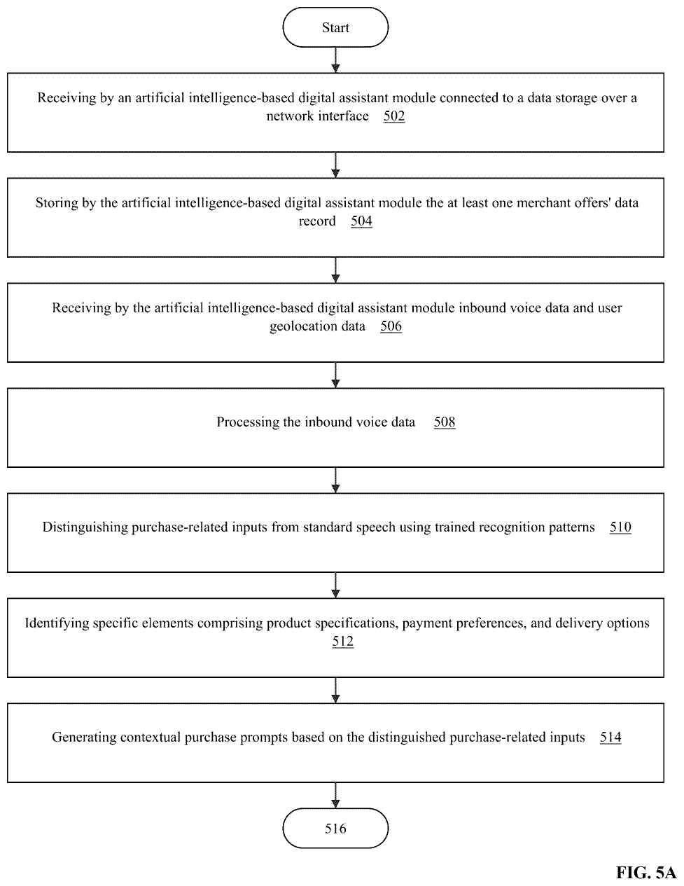

Even further, the FIG. 4 is a block diagram that further describes the system 102 from FIG. 1, according to some embodiments of the present disclosure. In some embodiments, receiving and processing user input. Receiving user input through multiple channels. Processing the multi-channel input by: Analyzing voice commands through the speech processing module 114. Processing text-based commands through the keyword recognition module 112. Integrating GPS data with search parameters. Maintaining context across input channels by: Preserving search context across input methods. Combining location context with user queries. Adapting input processing based on: User's preferred input methods.

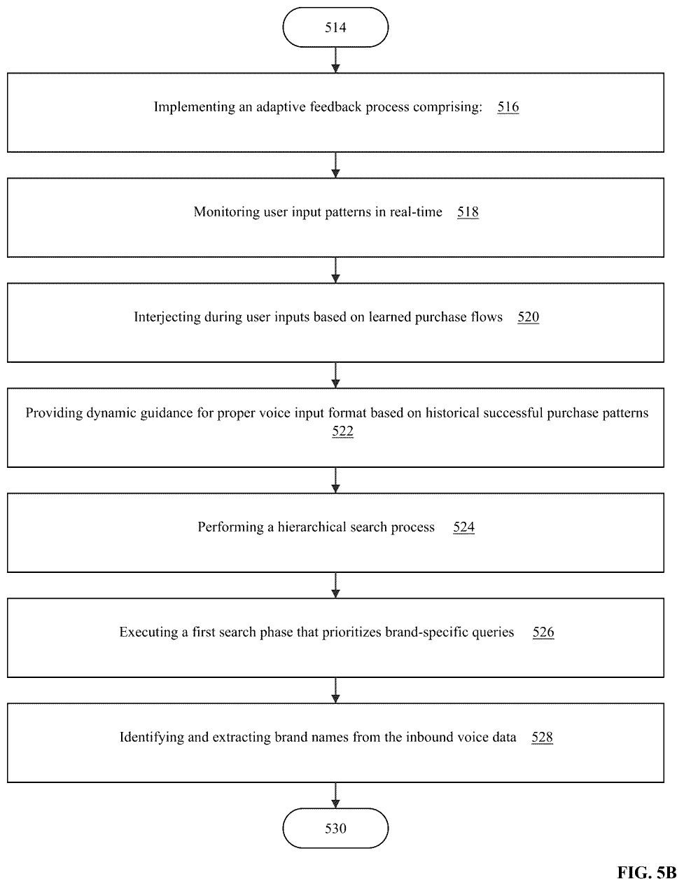

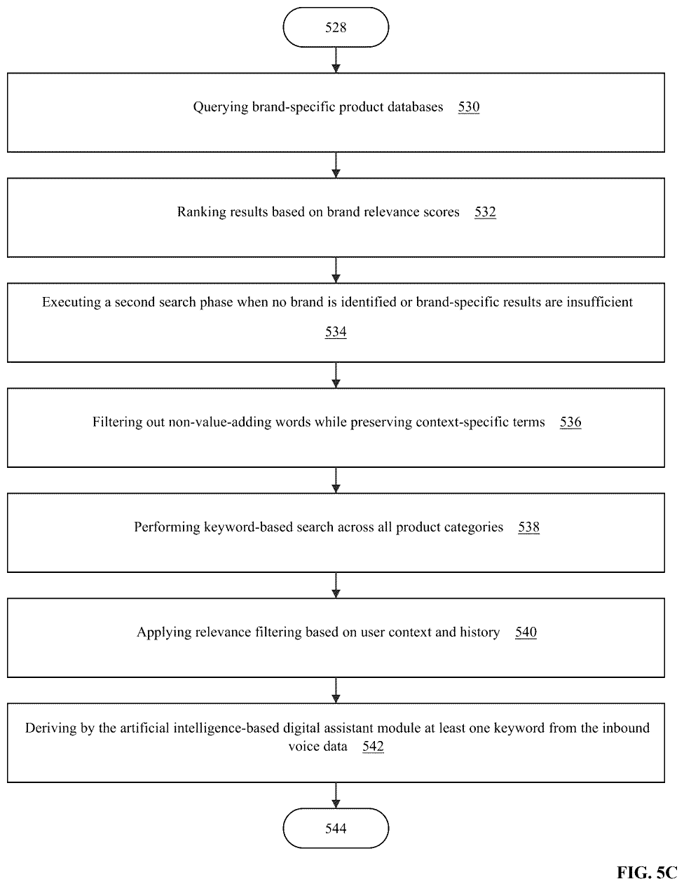

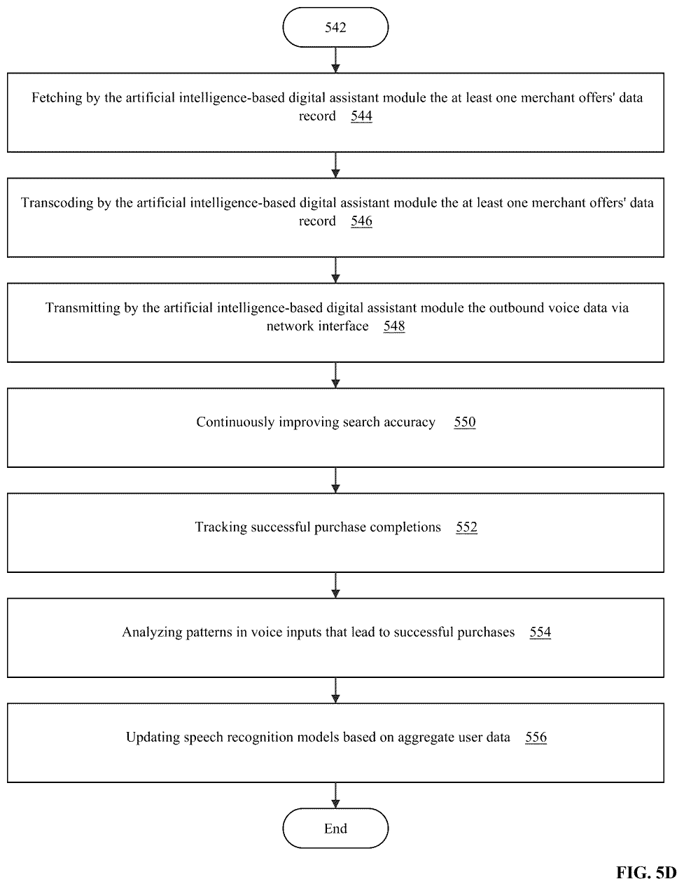

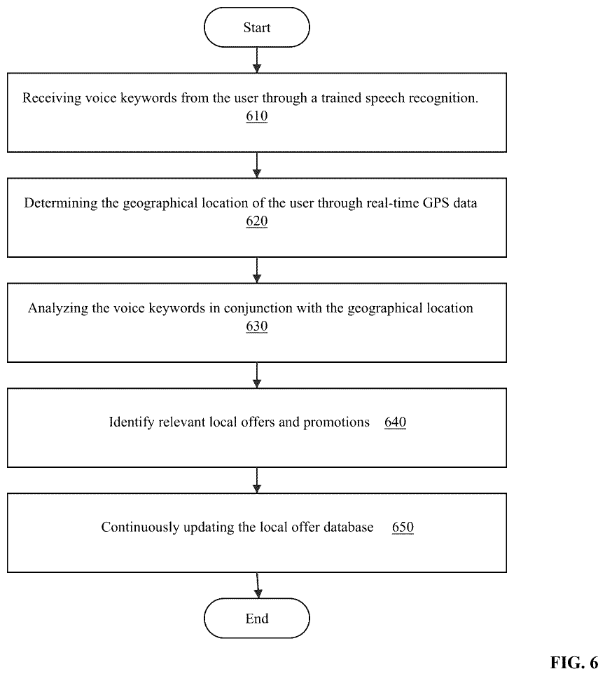

The further illustrations of FIGS. 5A, 5B, 5C and 5D are flowcharts that describe a method, according to some embodiments of the present disclosure. In some embodiments, at 502, the method may include receiving by an artificial intelligence-based digital assistant module connected to a data storage over a network interface at least one merchant offers'data record via a network interface. At 504, the method may include storing by the artificial intelligence-based digital assistant module the at least one merchant offers'data record in the data storage.

In some embodiments, at 506, the method may include receiving by the artificial intelligence-based digital assistant module inbound voice data and user geolocation data from a user communication device via the network interface. At 508, the method may include processing the inbound voice data by: At 510, the method may include distinguishing purchase-related inputs from standard speech using trained recognition patterns.

In some embodiments, at 512, the method may include identifying specific elements comprising product specifications, payment preferences, and delivery options. At 514, the method may include generating contextual purchase prompts based on the distinguished purchase-related inputs. At 516, the method may include implementing an adaptive feedback process comprising: At 518, the method may include monitoring user input patterns in real-time.

In some embodiments, at 520, the method may include interjecting during user inputs based on learned purchase flows. At 522, the method may include providing dynamic guidance for proper voice input format based on historical successful purchase patterns. At 524, the method may include performing a hierarchical search process comprising: At 526, the method may include executing a first search phase that prioritizes brand-specific queries by:

In some embodiments, at 528, the method may include identifying and extracting brand names from the inbound voice data. At 530, the method may include querying brand-specific product databases. At 532, the method may include ranking results based on brand relevance scores. At 534, the method may include executing a second search phase when no brand may be identified or brand-specific results may be insufficient by: At 536, the method may include filtering out non-value-adding words while preserving context-specific terms.

In some embodiments, at 538, the method may include performing keyword-based search across all product categories. At 540, the method may include applying relevance filtering based on user context and history. At 542, the method may include deriving by the artificial intelligence-based digital assistant module at least one keyword from the inbound voice data. At 544, the method may include fetching by the artificial intelligence-based digital assistant module the at least one merchant offers'data record from the data storage based on:

In some embodiments, at 546, the method may include transcoding by the artificial intelligence-based digital assistant module the at least one merchant offers'data record to outbound voice data. At 548, the method may include transmitting by the artificial intelligence-based digital assistant module the outbound voice data via network interface to the user communication device. At 550, the method may include continuously improving search accuracy by: At 552, the method may include tracking successful purchase completions. At 554, the method may include analyzing patterns in voice inputs that lead to successful purchases. At 556, the method may include updating speech recognition models based on aggregate user data.

In some embodiments, the steps of, the method may include 502 to 556. The at least one keyword. Inbound location data. Results of the hierarchical search process. User's historical purchase patterns. Refining search algorithms based on purchase completion rates. The data storage may comprise a database containing latest offers, business promotions, and live deals within a given geographical area of a user. The trained recognition patterns may be continuously updated based on successful purchase completions. The learned purchase flows may be derived from historical successful transactions. The hierarchical search process may adapt its ranking algorithms based on user-specific purchase patterns.

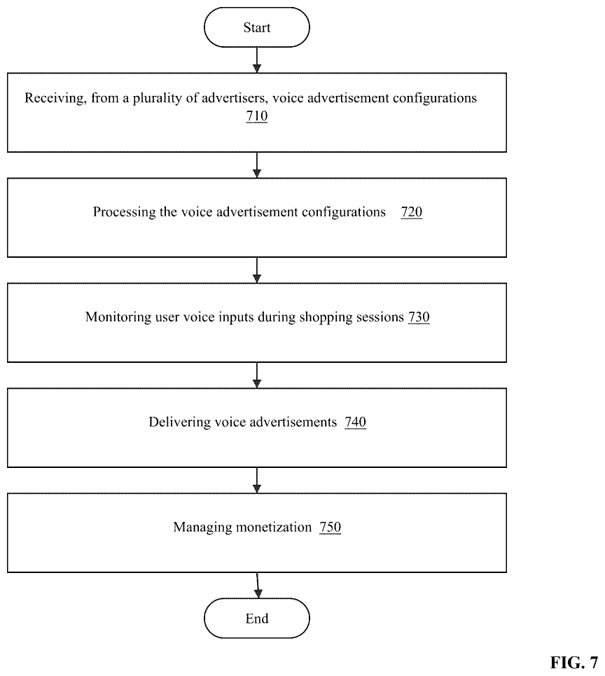

The further FIG. 6 is a flowchart that further describes the method from FIG. 5A, according to some embodiments of the present disclosure. In some embodiments, processing the inbound voice data further comprises, the method may include 610 to 650. Filter results based on proximity to user location. Rank results based on both relevance and distance. Present geographically-targeted voice results around the vicinity of the user. User interaction patterns with local offers. Successful purchase completions within specific geographical areas. Temporal relevance of offers and promotions.

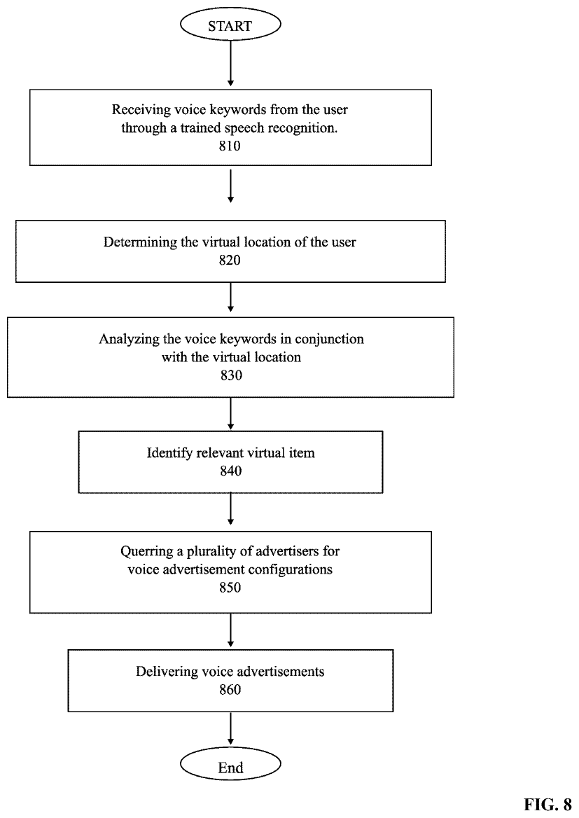

In some embodiments, FIG. 8 is a flowchart further illustrating the method from FIG. 5A, specifically within virtual reality (VR) environments. At 802, the method may include detecting a virtual object reference by the user. At 804, the method may include receiving a verbal query from the user. At 806, the method may include matching the user query with an advertiser's keyword set. At 808, the method may include retrieving a relevant ad or product information. At 810, the method may include delivering the audio ad contextually within the VR space. At 812, the method may include tracking user interaction and engagement for future personalization.

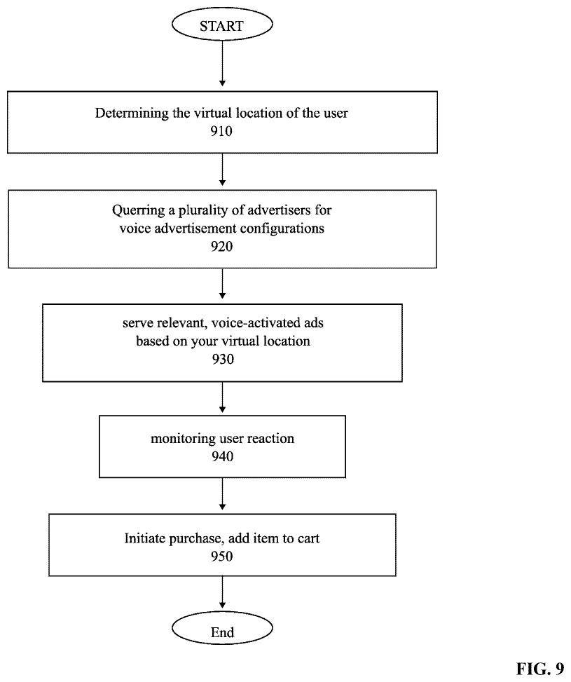

In some embodiments, FIG. 9 is a flowchart further illustrating AI platform integration. At 902, the method may include capturing user prompts within an AI system such as OpenAI. At 904, the method may include parsing the prompt for keywords. At 906, the method may include matching the keywords with advertiser-submitted triggers. At 908, the method may include retrieving associated audio ad content. At 910, the method may include preparing and formatting the ad for voice delivery. At 912, the method may include delivering the ad and collecting user feedback.

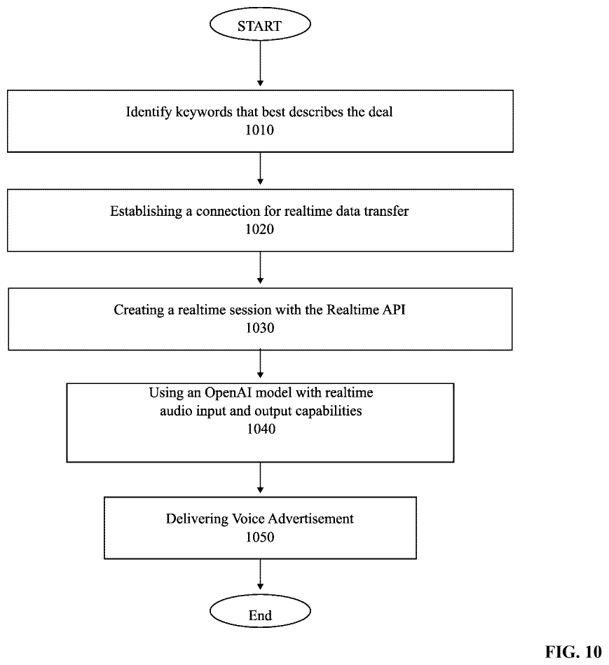

In some embodiments, FIG. 10 is a flowchart further illustrating standalone device operation. At 1002, the method may include detecting a device-based voice trigger e.g., “What's on sale?”. At 1004, the method may include accessing contextual data from the device e.g., time, location, app usage. At 1006, the method may include retrieving relevant offers from a merchant database. At 1008, the method may include generating a voice ad. At 1010, the method may include playing the voice ad on the device. At 1012, the method may include enabling in-app purchase or redirection to merchant platforms.

What is claimed is:

1. A voice-based digital assistant system for delivering contextually relevant, monetized voice advertisements across multiple platforms, comprising:
a. a digital web-based application configured to allow businesses to create and manage voice ads;
b. a monetization engine for voice software that can be integrated into virtual platforms including AI assistants and smart devices;
c. a voice ownership module allowing businesses to create branded, stand-alone voice marketing assistants.

2. The system of claim 1, wherein the web-based application enables advertisers to select keywords that trigger ad playback when queried on AI platforms.

3. The system of claim 1, wherein the monetization engine is embedded in platforms such as OpenAI, smart TVs, and VR environments, providing keyword-triggered, voice-delivered ads.

4. The system of claim 1, wherein the voice ownership module enables companies to license and customize a voice assistant for interactive product marketing and sales.

5. The system of claim 4, wherein voice commands allow users to:
a. request offers on products/services by speaking into a smart device;
b. receive interactive voice ads in response;
c. complete purchases using integrated voice-activated checkout flows.

6. A digital assistant system configured for deployment on OpenAI platforms, comprising:
a. a voice ad generation module;
b. a keyword matching system responsive to user prompts;
c. a voice playback interface for delivering the advertisement through OpenAI.

7. The system of claim 6, wherein keyword prompts by users on OpenAI trigger contextually relevant voice ads about businesses with matched deals.

8. A voice-interactive advertisement system for use in virtual reality environments, comprising:
a. a voice input module for user commands within a VR setting;
b. a voice-responsive engine that delivers interactive voice ads based on the user's virtual environment and queries.

9. The system of claim 8, wherein voice commands initiate product inquiries, and the system responds with immersive audio ads or purchase prompts.

10. The system of claim 8, further configured to enable direct purchases within VR via voice commands.

11. The system of claim 1, further comprising a geolocation module and a keyword recognition engine for delivering location-based, voice-triggered ads.

12. The system of claim 11, wherein user utterances are processed for purchase intent, triggering contextually relevant offers through an adaptive feedback module.

13. A voice-based digital assistant method, comprising:
a. receiving voice or text input from a user;
b. parsing the input for keywords;
c. fetching matching merchant offers;
d. transcoding offer content to audio;
e. transmitting the audio to a user device.

14. The method of claim 13, further comprising adapting future voice recognition patterns based on previous successful purchase flows.

15. The method of claim 13, further comprising filtering non-value-adding words and preserving context to improve search accuracy and ad targeting.
